(19) United States
(12) Patent Application Publication
(10) Pub. No.: US 2003/0066946 A1
(43) Pub. Date: Apr. 10, 2003

(54) Stabilized pulse light drive circuit apparatus and method for endpoint detection in a semiconductor process

(75) Inventor: Michael N. Grimbergen, Redwood City, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/974,922

(22) Filed: Oct. 9, 2001

(51) Int. Cl. G01J 1/32

(52) U.S. Cl. 250/205

(57) ABSTRACT

An apparatus and method for stabilizing pulse light intensity from a pulse light for semiconductor manufacturing process metrology system is disclosed. The apparatus and method are directed to a stabilized pulse light drive circuit including a pulse light positioned so as to direct light into a process reactor of a semiconductor wafer manufacturing system. A light detector detects light in the process reactor emitted from the pulse light and generates a signal representing the light intensity in the reactor chamber. The light intensity is integrated and compared with a desired preset intensity level. When the comparison yields a substantially equal result, power to the pulse light is shut off, thereby ensuring a substantially constant light intensity in the process reactor.

### FIELD OF THE INVENTION

The present invention relates to a method and apparatus for detection of the endpoint of a particular process being performed on a semiconductor substrate. More particularly, the present invention is directed to a pulse light drive circuit that stabilizes light pulse intensity for use in endpoint detection in a semiconductor process.

### BACKGROUND OF THE INVENTION

In integrated circuit fabrication, semiconductor, dielectric, and conductor materials are deposited on a substrate and etched to form patterns of gates, vias, contact holes, or interconnect lines. The layers typically are deposited by chemical vapor deposition, physical vapor deposition, or thermal oxidation processes. In integrated circuit fabrication, it is desirable to have metrology system integrated with the fabrication equipment in order to monitor the fabrication of the devices. An example of such a metrology system is an endpoint detection method and apparatus that terminates a semiconductor process as soon as the desired thickness of a layer being processed on the substrate is achieved, and without damaging the underlying layers. Another example of a metrology system is an optical critical measurement (CD) apparatus.

It is further desirable to have a metrology system, such as an endpoint detection or CD measurement system, that provides a signal prior to etching through, or deposition of, an entire layer to allow the etching or deposition process to be changed before completion of the process. It is also desirable to have an endpoint detection system, which detects a change in thickness of a layer being processed, with high resolution, low signal to noise ratio, and high reliability. Obtaining these desired features becomes a principal object of the invention. Other objects will become apparent from the description, which follows.

### SUMMARY OF THE INVENTION

The present invention provides an apparatus and method for stabilizing pulse light intensity from a pulse light for a metrology system, such as an endpoint detection or CD measurement system. Specifically, the present invention provides a stabilized pulse light drive circuit for semiconductor metrology system, including a pulse light source, an energy source connected to the pulse light source, and a light detector positioned to receive pulse light from the pulse light source. A pulse light drive circuit according to the invention also includes a feedback signal processing circuit that compares a desired light intensity level with the detected preset light intensity level fed back from the light detector. A cut-off switch cuts off energy to the pulse light source after the light detector detects a predetermined pulse light intensity level.

With the method and apparatus of the invention as disclosed, a pulsed flash light drive circuit is modified to cut off the pulse prematurely when a preset amount of light is detected. The same preset amount of light will be produced for each pulse, eliminating the usual 1-3% variation in light output (pulse-to-pulse) seen in conventional light systems. A wavelength selective element can be added to the sensor to provide greater stability at a specific wavelength band when desired.

According to another aspect of the invention, the light drive circuit is modified to produce multiple flashes of light at a lower intensity at a first predetermined rate, rather than using a feedback signal from a sensor. A lower power light can flash at up to 100× the rate of a standard pulse light, providing up to 5× or more noise reduction. The flash rate also can be varied to adjust the desired predetermined level without changing the voltage on the capacitor. Standard flash lights provide stability between flashes on the order of 1-2%. The drive circuit provides a stabilized light output in which the stability is better than 0.5%.

The foregoing and other features, aspects, and advantages of the present invention will be better understood from the following drawings, description and appended claims, which illustrate examples of the invention. While the description and drawings below illustrate exemplary features of the invention, it is to be understood that each of the features can be used in the invention in general, not merely in the context of the particular drawings, and the invention includes any combination of these features and their equivalents.

### BRIEF DESCRIPTION OF THE DRAWINGS

FIG. 1 is a schematic block diagram of a semiconductor apparatus and metrology system to which the drive circuit of the invention can be applied.

FIGS. 2A and 2B are schematic graphs illustrating, for reference, light pulse intensity over time and the integrated intensity over time, respectively, without the intensity feedback control of the present invention.

FIG. 3 is a schematic diagram of a stabilized pulse light drive circuit according to a first embodiment of the present invention.

FIG. 4 is a schematic diagram of another stabilized pulse light drive circuit according to a second embodiment of the present invention.

FIGS. 5A and SB are schematic graphs illustrating light pulse intensity over time and the integrated intensity over time, respectively; with intensity feedback control provided by a stabilized pulse light drive circuit according to FIG. 3.

FIGS. 6A and 6B are schematic graphs illustrating, for reference, high flash rate light pulse intensity over time and the integrated intensity over time, respectively; with intensity feedback control provided by a stabilized pulse light drive circuit according to FIG. 3.

### DESCRIPTION OF EXEMPLARY EMBODIMENT

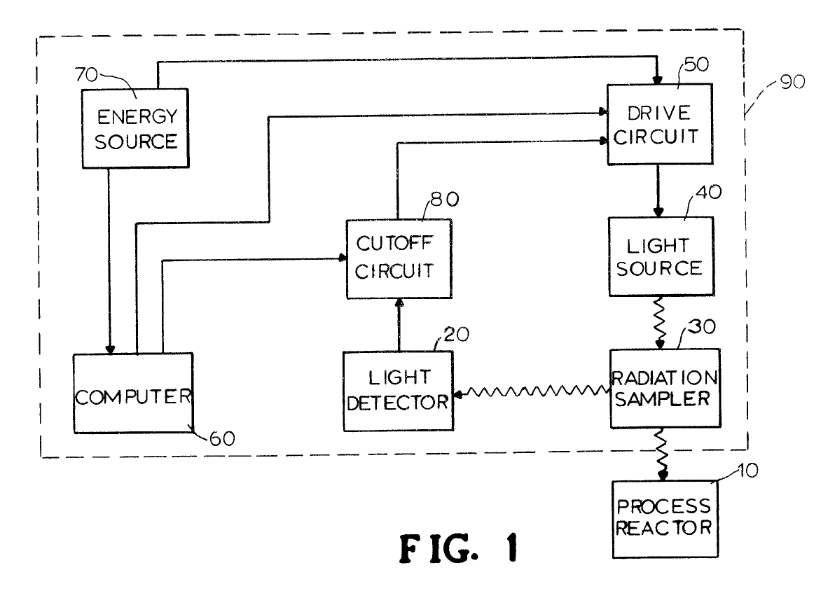

An example of a representative semiconductor processing system of the type to which the drive circuit of the invention can be applied is schematically illustrated in the block diagram from FIG. 1. In this system, a substrate (not shown) is processed in a semiconductor-processing reactor 10. Process gas is introduced into process reactor 10 through a gas distribution system (not shown) that includes a process gas supply and a gas flow control system. The gas distribution system can comprise, for example, gas outlets located at or around the periphery of the substrate, or a showerhead mounted on the ceiling of process reactor 10 with outlets therein. Spent process gas and etchant byproducts are exhausted from process reactor 10 through an exhaust system (not shown).

Process reactor 10 is illustrated for the purpose of showing how the drive circuit of the present invention is applied in association with a semiconductor metrology apparatus, such as, endpoint detection system 90 for detecting an endpoint of a process being performed in process reactor 10. Other metrology systems, such as, for example, a CD measurement system, have generally the same structure. In this example, the metrology system 90 comprises a pulse light source 40 and drive circuit 50 for emitting a light beam, a radiation sampler 30 for positioning and/or filtering an incident light beam onto the substrate surface and directing incident light onto a light detector 20 that measures an intensity of a reflected light beam that is reflected from the substrate surface. Light detector 20 is schematically illustrated as being located outside process reactor 10 but could also be positioned within process reactor 10 as well. An energy source 70 is schematically illustrated, connected to light source 40 and a computer system 60. Computer system 60 calculates and stores portions of the real-time measured waveform spectra of light reflected from the layer being processed on the substrate and adjusts process conditions in process reactor 10, accordingly.

Pulse light source 40 can be a monochromatic or polychromatic light source that generates an incident light beam having intensity sufficiently high to provide a reflected light beam that is reflected from a layer on the substrate, when the layer is a suitable thickness, with a measurable intensity. Pulse light source 40 could be, for example, Xenon or other flash-type light that generates an emission spectrum of light in a particular wavelength range. Pulse light source 40 can be filtered to provide an incident light beam having selected frequencies, or particular emission spectra wavelengths can be used, or color filters can be placed in front of light detector 20 to filter out all undesirable wavelengths except the desired wavelength of light, prior to measuring the intensity of the reflected light beam entering light detector 20. Pulse light source 40 also could comprise a monochromatic light source that provides a selected wavelength of light, for example, a He—Ne or ND-YAG laser.

Light detector 20 comprises a light sensitive electronic component, such as a photovoltaic cell, photodiode, phototransistor, or charge coupled device, which provides a signal in response to a measured intensity of the reflected light beam that is reflected from the substrate surface. The signal can be in the form of a change in the level of a current passing through an electrical component or a change in a voltage applied across an electrical component. The reflected light beam undergoes constructive and/or destructive interference, which increases or decreases the intensity of the light beam, and light detector 20 provides an electrical output signal in relation to the measured intensity of the reflected light beam. The electrical output signal is plotted as a function of time to provide waveform spectra having numerous waveform patterns corresponding to the varying intensity of the reflected light beam.

A computer program on a computer system 60 compares the characteristics of the measured waveform pattern of the reflected light beam to a stored characteristic waveform pattern and determines the process condition, such as the endpoint of the etching process or the CD measurement of the fabricated structures. The computer program can also include program code to calculate in real time, the thickness of the layer being etched that remains on the substrate and accordingly adjust the process conditions in the process reactor 10. The computer program also can count the number of maxima and minima intensity peaks of the reflected light beam and, after a predetermined number of peaks are reached, alter process conditions in process reactor 10, according to programmed guidelines.

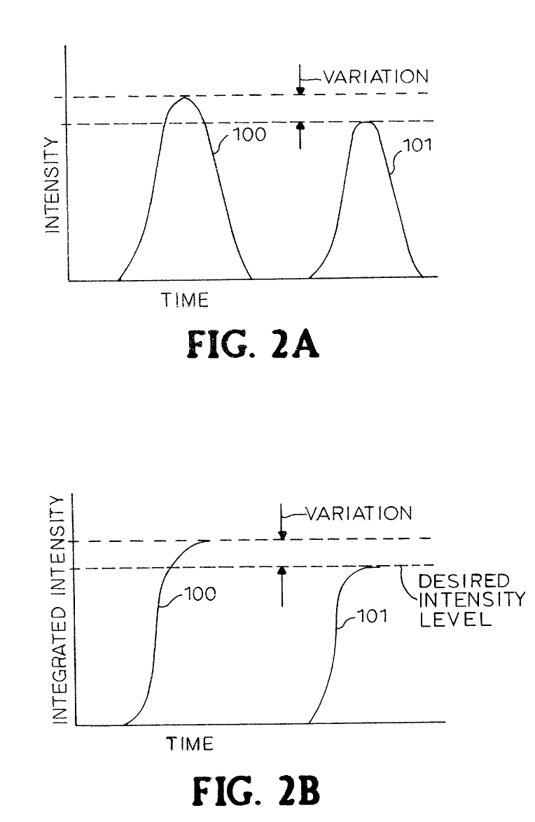

FIGS. 2A and 2B are schematic graphs generally illustrating light pulse waveforms plotted as intensity vs. time, without the feedback control provided by the present invention. FIG. 2A illustrates two light pulse waveforms, 100 and 101, and FIG. 2B illustrates the same two light pulse waveforms 100 and 101 plotted as integrated intensity. As can be seen from the schematic graphs, light pulse 100 has a slightly higher intensity level than light pulse 101. The variation shown in FIGS. 2A and 2B has been exaggerated in order to illustrate the difference in maxima intensity peaks. Generally, variation in light pulse intensity can be in the range of 1% to 3%. FIG. 2B illustrates the integrated intensity variation. The variations in pulse intensity can impact the accuracy of the metrology performed. In order to improve the accuracy, the circuitry of the present invention is directed to a stabilized pulse light drive circuit that is capable of producing light pulses having substantially the same integrated intensity level.

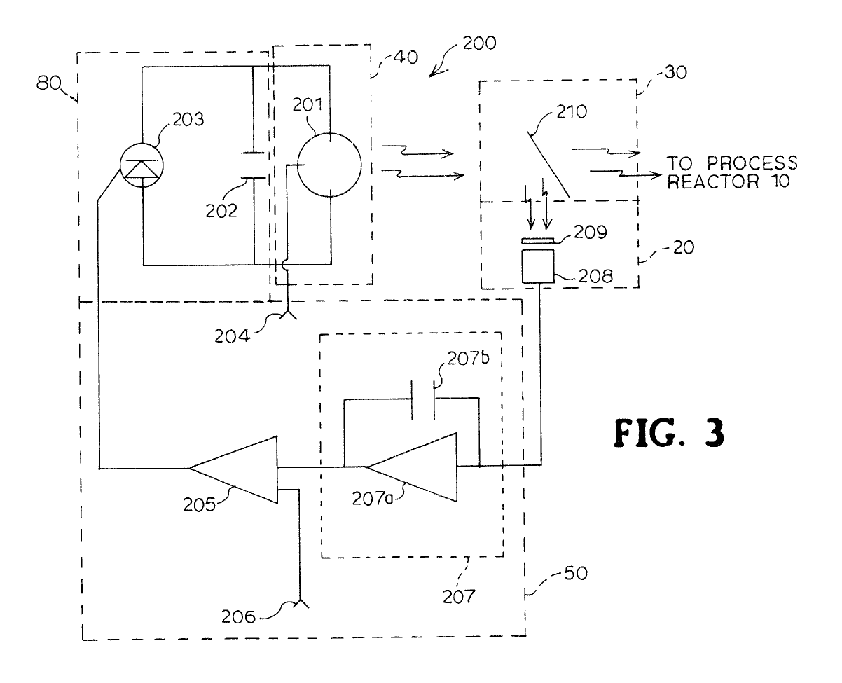

FIG. 3 illustrates in schematic form a stabilized pulse light drive circuit 200 using a feedback loop according to a first embodiment of the present invention. The pulse light drive circuit 200 includes a pulse light 201 connected to an energy source such as capacitor 202. Pulse light 201 is positioned so as to project a light pulse into the reactor chamber as described above. A trigger cut off switch 203 is connected with capacitor 202 and the output of a threshold comparator 205. Power is supplied to pulse light 201 as capacitor 202 discharges. Start trigger 204 initiates the discharge of light pulses from pulse light 201.

As light pulses are emitted from pulse light 201, the light strikes deflector 210, which directs at least a portion of the light to light detector 208, optionally through a filter element 209. Deflector 210 can be of any known type of construction that allows a portion of the light to be reflected to light detector 208 and the remaining light to pass therethrough into the reactor chamber. Light entering light detector 208 is converted into a signal representing the intensity of the light pulse as emitted from pulse light 201, and the light intensity signal is sent to a signal processing circuit 207.

Signal processing circuit 207 includes a signal integrator 207a and a capacitor 207b, which acts as a charge amplifier. The light intensity signal entering signal processing circuit 207 is amplified and integrated, and is sent to the threshold comparator 205. Threshold comparator 205 compares the integrated intensity value from processing circuit 207 with a predetermined light intensity value provided through line 206. When the integrated intensity value is substantially the same as the predetermined light intensity value, a signal is sent to trigger cut-off switch 203. Trigger cut-off switch 203 cuts off power to pulse light 201, thereby truncating the light pulse emitted from pulse light 201. Truncation of the light pulse based on the comparison of integrated light intensity and a predetermined integrated intensity reduces light intensity variations on a pulse-by-pulse basis.

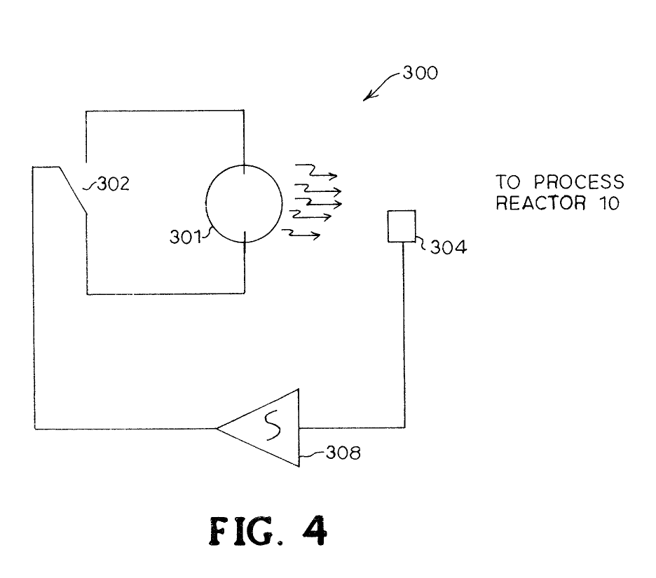

FIG. 4 illustrates a second embodiment of a stabilized pulse light drive circuit 300 according to the invention. Pulse light drive circuit 300 includes a pulse light 301 connected to a power source (such as energy source 80 as schematically shown in FIG. 1) through a shut off switch 302. As a series of lower intensity level light pulses are emitted from pulse light 301, light detector 304 detects them. Light detector 304 again can use an optional filter element (not shown). Light entering light detector 304 is converted into a light intensity signals that is sent to an integrator/comparator 308. Integrator/comparator 308 integrates the light intensity signals. The integrated light intensity values are compared to a predesired integrated light intensity value stored in computer 60 (FIG. 1). When the result of the comparison is that the signals are substantially the same, switch 302 is closed and pulse light 301 stops emitting light pulses.

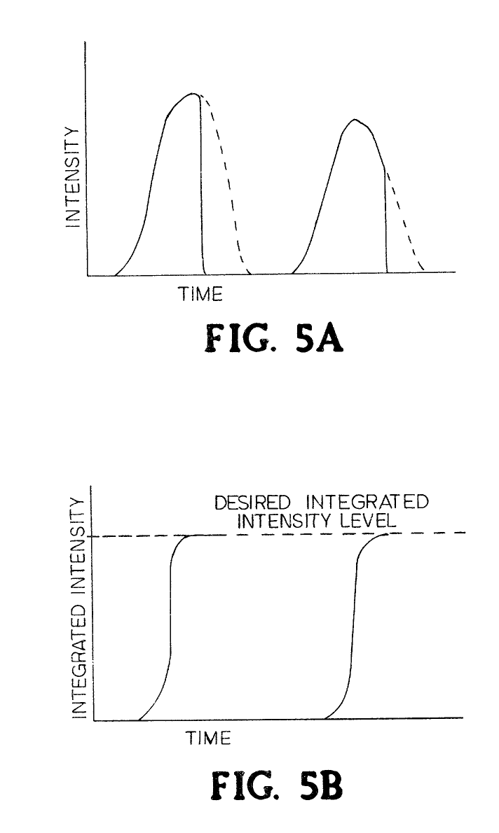

FIGS. 5A and 5B schematically illustrate light pulse intensity over time and the integrated intensity over time, respectively, with intensity feedback control provided by a stabilized pulse light drive circuit according to a first embodiment of the invention as shown in FIG. 3. Again, maxima intensity peak variation has been exaggerated. As seen in FIG. 5A, the emitted light pulses vary in intensity. As described above, as light is emitted from pulse light 201 (FIG. 3), a portion thereof is converted into an integrated intensity signal. The integrated intensity value is compared to a desired integrated intensity level, and when the values are substantially the same, as shown in FIG. 5B, a signal is sent to trigger cut-off switch 203 (FIG. 3), which shuts off power to pulse light 201, thereby truncating the light pulse, as shown by the dotted line in FIG. 5A. This truncation produces a substantially constant pulse-to-pulse integrated light intensity level in the reactor chamber, thereby improving the accuracy of the metrology system.

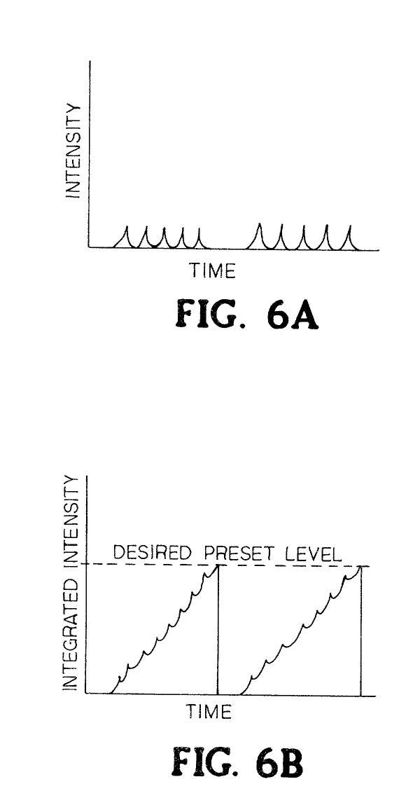

The pulse light emission from the drive circuit according to FIG. 4 is graphically illustrated in FIGS. 6A and 6B. As seen in FIG. 6A, the pulse light drive circuit of the second embodiment of the present invention (FIG. 4) produces multiple flashes of light at lower intensity, for example than the light intensity generated in the pulse light circuit illustrated in FIG. 3, at a first predetermined rate. FIG. 6B graphically illustrates integrated light intensity values. When the integrated light intensity values reach the desired preset level, shut off switch 302 (FIG. 4) is closed, shutting off power to pulse light 301 (FIG. 4). This arrangement can provide several benefits, such as the use of a lower powered light source to produce lower intensity flashes. A lower power light can flash at up to 100× the rate of a typical higher power light source, and provide up to 5× or more noise reduction in the power supply circuit. The flash rate also can be varied to adjust the desired predetermined level without changing the voltage on the capacitor.

The above detailed description of a preferred embodiment of the invention sets forth the best mode contemplated by the inventor for carrying out the invention at the time of filing this application and is provided by way of example and not as a limitation. Accordingly, various modifications and variations obvious to a person of ordinary skill in the art to which it pertains are deemed to lie within the scope and spirit of the invention as set forth in the following claims.

What is claimed is:

1. A pulse light drive circuit for semiconductor metrology apparatus, comprising:
(a) a pulse light source;
(b) an energy source connected to the pulse light source;
(c) a light detector positioned to receive pulse light from the pulse light source; and
(d) a drive circuit connecting the pulse light source, energy source and light detector, the drive circuit further comprising a signal processing circuit, and a cut-off switch adapted to cut off energy from the energy source to the pulse light source after a predetermined pulse light integrated intensity level is detected by the light detector.

2. A pulse light drive circuit for semiconductor metrology apparatus according to claim 1, wherein the energy source comprises a capacitor, and the signal processing circuit further comprises an integrator and a threshold comparator.

3. A pulse light drive circuit for semiconductor metrology apparatus according to claim 1, wherein the light detector further comprises a filter element.

4. A pulse light drive circuit for semiconductor metrology apparatus according to claim 3, wherein the filter element comprises a wavelength selective element.

5. A pulse light drive circuit for semiconductor metrology apparatus according to claim 2, wherein the light detector produces a pulse light intensity signal, and the integrator integrates the pulse light intensity signal into an integrated light intensity signal.

6. A pulse light drive circuit for semiconductor metrology apparatus according to claim 2, wherein the cut-off switch further comprises a trigger switch connected between the threshold comparator and the capacitor.

7. A pulse light drive circuit for semiconductor metrology apparatus according to claim 6, wherein the pulse light source generates a light pulse having a predetermined duration, and the trigger switch cuts off energy to the pulse light source when the integrated light intensity signal reaches a predetermined level.

8. A pulse light drive circuit for semiconductor metrology apparatus according to claim 1, wherein the cut-off switch is connected between the energy source and the pulse light source, and the signal processing circuit further comprises an integrator connected between the light detector and the cut-off switch.

9. A pulse light drive circuit for semiconductor metrology apparatus according to claim 8, wherein the cut-off switch is repeatedly turned on and off to generate a plurality of light pulses, each having a predetermined duration.

10. A pulse light drive circuit for semiconductor metrology apparatus according to claim 9, wherein the light detector produces a pulse light intensity signal for each of the plurality of light pulses, and the integrator integrates the pulse light intensity signals into an integrated light intensity signal.

11. A pulse light drive circuit for semiconductor metrology apparatus according to claim 10, wherein the cut-off switch cuts off energy to the pulse light source when the integrated light intensity signal of the plurality of light pulses reaches a desired preset level.

12. A semiconductor manufacturing process metrology apparatus comprising a pulse light positioned so as to direct light into a reactor chamber of a semiconductor manufacturing system, a power source, and a light detector to detect light in the reactor chamber emitted from the pulse light, the metrology apparatus further comprising:
a pulse light drive circuit connecting the power source and the pulse light, the pulse light drive circuit further comprising a trigger circuit adapted to cut off power from the power source to the pulse light after a predetermined intensity of light is detected in the reactor chamber by the light detector.

13. A semiconductor manufacturing process metrology apparatus according to claim 12, wherein the power source comprises a capacitor, and the trigger circuit further comprises an integrator and a threshold comparator.

14. A semiconductor manufacturing process metrology apparatus according to claim 12, wherein the light detector further comprises a filter element.

15. A semiconductor manufacturing process metrology apparatus according to claim 14, wherein the filter element comprises a wavelength selective element.

16. A semiconductor manufacturing process metrology apparatus according to claim 13, wherein the light detector produces a pulse light intensity signal, and the integrator integrates the pulse light intensity signal into an integrated light intensity signal.

17. A semiconductor manufacturing process metrology apparatus according to claim 16, wherein the trigger circuit further comprises a trigger switch connected between the threshold comparator and the capacitor.

18. A semiconductor manufacturing process metrology apparatus according to claim 17, wherein the pulse light generates a light pulse having a predetermined duration, and the trigger switch cuts off power to the pulse light when the integrated light intensity signal reaches a predetermined level.

19. A semiconductor manufacturing process metrology apparatus according to claim 12, further comprising a cut-off switch connected between the power source and the pulse light, and the trigger circuit further comprises an integrator connected between the light detector and the cut-off switch.

20. A semiconductor manufacturing process metrology apparatus according to claim 19, wherein the cut-off switch is repeatedly turned on and off to generate a plurality of light pulses, each having a predetermined duration.

21. A semiconductor manufacturing process metrology apparatus according to claim 20, wherein the light detector produces a pulse light intensity signal for each of the plurality of light pulses, and the integrator integrates the pulse light intensity signals into an integrated light intensity signal.

22. A semiconductor manufacturing process metrology apparatus according to claim 21, wherein the cut-off switch cuts off power to the pulse light when the integrated light intensity signal of the plurality of light pulses reaches a predetermined level.

23. A method for effecting endpoint detection in a semiconductor wafer manufacturing process, comprising:
(a) generating one or more light pulse from a light source and introducing the at least one light pulse into a process reactor of a semiconductor wafer processing system;
(b) detecting light intensity in the process reactor with a light-detecting device, and converting the detected light intensity into a detected light intensity value;
(c) comparing the detected light intensity value with a stored desired light intensity value; and
(d) cutting off power to the light source when the stored desired light intensity value and the detected light intensity value are substantially the same.

24. A method for effecting endpoint detection in a semiconductor wafer manufacturing process according to claim 23, further comprising filtering the one or more light pulses through a filtering element in a light detection device.

25. A method for effecting endpoint detection in a semiconductor wafer manufacturing process according to claim 24, further comprising selecting a predetermined wavelength of the one or more light pulses that passes through the filtering element.

26. A method for effecting endpoint detection in a semiconductor wafer manufacturing process according to claim 23, wherein detecting light intensity in the process reactor further comprises integrating the detected light intensity into an integrated light intensity value.

27. A method for effecting endpoint detection in a semiconductor wafer manufacturing process according to claim 26, wherein the one or more light pulses each are of a predetermined duration, and the power is cut off when the integrated light intensity value reaches a predetermined level.

28. A method for effecting endpoint detection in a semiconductor wafer manufacturing process according to claim 23, further comprising repeatedly turning on and off a switch to generate a plurality of light pulses, each having a predetermined duration.

29. A method for effecting endpoint detection in a semiconductor wafer manufacturing process according to claim 28, further comprising integrating a detected light intensity for each of the plurality of light pulses and combining the integrated pulse light intensity signals into an integrated detected light intensity value.

30. A method for effecting endpoint detection in a semiconductor wafer manufacturing process according to claim 29, wherein power to the light source is cut off when the integrated detected light intensity signal of the plurality of light pulses reaches a predetermined level.

31. A method for improving endpoint detection in a semiconductor wafer manufacturing process using an optical monitoring device, comprising:
(a) connecting power to a light source and generating a light event in a process reactor of a semiconductor wafer manufacturing system;
(b) detecting the light event in the process reactor and converting the detected light event into a light intensity value;
(c) integrating the light intensity value into an integrated light intensity value;
(d) comparing the integrated light intensity value to a predesired light intensity value; and
(e) disconnecting the power to the light source when the integrated light intensity signal and the predetermined light intensity signal are the same.

32. A method for improving endpoint detection in a semiconductor wafer manufacturing process using an optical monitoring device according to claim 31, wherein generating a light event further comprises generating a single light pulse having a predetermined duration.

33. A method for improving endpoint detection in a semiconductor wafer manufacturing process using an optical monitoring device according to claim 31, wherein generating a light event comprises generating a plurality of light pulses each having a duration shorter than a duration of the light event.

34. A method for improving endpoint detection in a semiconductor wafer manufacturing process using an optical monitoring device according to claim 33, wherein detecting the light event comprises:
(a) detecting each light pulse; and
(b) converting each detected light pulse into a light intensity value.

35. A method for improving endpoint detection in a semiconductor wafer manufacturing process using an optical monitoring device according to claim 34, wherein integrating the light intensity signal comprises integrating each light intensity signal into a plurality of integrated pulse light intensity signals, and combining the plurality of integrated light intensity signals to obtain the integrated light intensity signal.
